(19) United States
(12) Patent Application Publication
(10) Pub. No.: US 2009/0231249 A1
(43) Pub. Date: Sep. 17, 2009

(54) ELECTRONIC DEVICE AND HOLDING DEVICE WITH VOLTAGE-REGULATION COLOR-CHANGING ELEMENT

(76) Inventors: Wen-Chun Wang, Taichung City (TW); Chin-Chang Liu, Taichung County (TW); Sheng-Yuan Chen, Yunlin County (TW)

Correspondence Address: Muncy, Geissler, Olds & Lowe, PLLC, P.O. BOX 1364, FAIRFAX, VA, 22038-1364, US

(21) Appl. No.: 12/401,437

(22) Filed: Mar. 10, 2009

Related U.S. Application Data
(60) Provisional application No. 61/035,528, filed on Mar. 11, 2008.

(51) Int. Cl. G09G 3/32

(52) U.S. Cl. 345/83

(57) ABSTRACT

An electronic device with at least one voltage-regulation color-changing element has a display section and a housing substantially surrounding the display section. The voltage-regulation color-changing element, which is provided on at least one of the display section and the housing and supplied with a voltage by a voltage source of the electronic device, is allowed to tune between different wavelength bands of reflected light to vary the color of at least part of the electronic device so as to provide specific visual effects.

### CROSS REFERENCE TO RELATED APPLICATION

This application claims benefit of U.S. provisional application No. 61/035,528 filed on Mar. 11, 2008 under 35 U.S.C. §119(e); the entire contents of which are hereby incorporated by reference.

### BACKGROUND OF THE INVENTION

1. Field of the Invention

The invention relates to an electronic device and a holding device each having at least one voltage-regulation color-changing element.

2. Description of the Related Art

FIG. 1 shows a schematic diagram of a conventional voltage-regulation color-changing element 100. Referring to FIG. 1, the color-changing element 100 includes a pair of electrodes 102a and 102b permeated with an electrolyte, a cross-linked metallopolymer 104 provided between the pair of electrodes 102a and 102b, and plenty of silica microspheres 106 embedded within the cross-linked metallopolymer 104. When the electrodes 102a and 102b are applied with a voltage, the cross-linked metallopolymer 104, as a result of the penetration of the electrolyte, expands to space the silica microspheres 106 apart and thus change the refraction index of the color-changing element 100. As the distance between each two silica microspheres 106 becomes longer, the output wavelength band of reflected light increases correspondingly. Hence, through the regulation of applied voltages, red light R, green light G, blue light B, and other wavelength bands of reflected light are obtained to bring out color-changing effects.

The color-changing element 100 is widely used since it is light, thin, and power-saving. Thus, how to incorporate the voltage-regulation color-changing element 100 into different kinds of appliances to provide specific visual effects is an important design topic to be dealt with.

### BRIEF SUMMARY OF THE INVENTION

The invention relates to an electronic device and a holding device each having at least one voltage-regulation color-changing element to bring different color, provide specific visual effects, and deliver information by the recognition of colors.

According to an embodiment of the invention, an electronic device with at least one voltage-regulation color-changing element has a display section and a housing substantially surrounding the display section. The voltage-regulation color-changing element, which is provided on at least one of the display section and the housing and supplied with a voltage by a voltage source of the electronic device, is allowed to tune between different wavelength bands of reflected light to vary the color of at least part of the electronic device so as to provide specific visual effects.

In one embodiment, the electronic device is a cellular phone, a personnel digital assistant, a notebook, a digital photo frame, an e-paper, an electronic notice board, or one of home electric appliances.

In one embodiment, the voltage-regulation color-changing element is embedded in the electronic device.

In one embodiment, the voltage-regulation color-changing element includes a pair of electrodes and a cross-linked metallopolymer, and the pair of electrodes and the cross-linked metallopolymer are integrated into the liquid crystal cells.

According to another embodiment of the invention, a holding device with at least one voltage-regulation color-changing element has a display section and a background section surrounding the display section. The voltage-regulation color-changing element, which is provided on both the display section and the background section and supplied with a voltage by a voltage source, is allowed to tune between different wavelength bands of reflected light to vary the color of the display section and the background section so as to provide specific visual effects.

According to the above embodiments. According to the above embodiments, the voltage-regulation color-changing element is combined with a holding device to bring different colors and provide specific visual effects, to deliver information by the recognition of colors, and to show at least one pattern, alphabet or symbol. 10017] Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 shows a schematic diagram of a conventional voltage-regulation color-changing element.

FIG. 2 shows a schematic diagram illustrating an electronic device having a voltage-regulation color-changing element according to an embodiment of the invention.

FIG. 3 shows a schematic diagram illustrating an electronic device having a voltage-regulation color-changing element according to another embodiment of the invention.

FIG. 4 shows a schematic diagram illustrating an electronic device having a voltage-regulation color-changing element according to another embodiment of the invention.

FIG. 5 shows a schematic diagram illustrating an electronic device having a voltage-regulation color-changing element according to another embodiment of the invention.

FIG. 6 shows a schematic diagram illustrating a holding device having a voltage-regulation color-changing element according to another embodiment of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and variations thereof herein are used broadly and encompass direct and indirect connections, couplings, and mountings. Similarly, “adjacent to” and variations thereof herein are used broadly and encompass directly and indirectly “adjacent to”. Therefore, the description of “A” component “adjacent to” “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

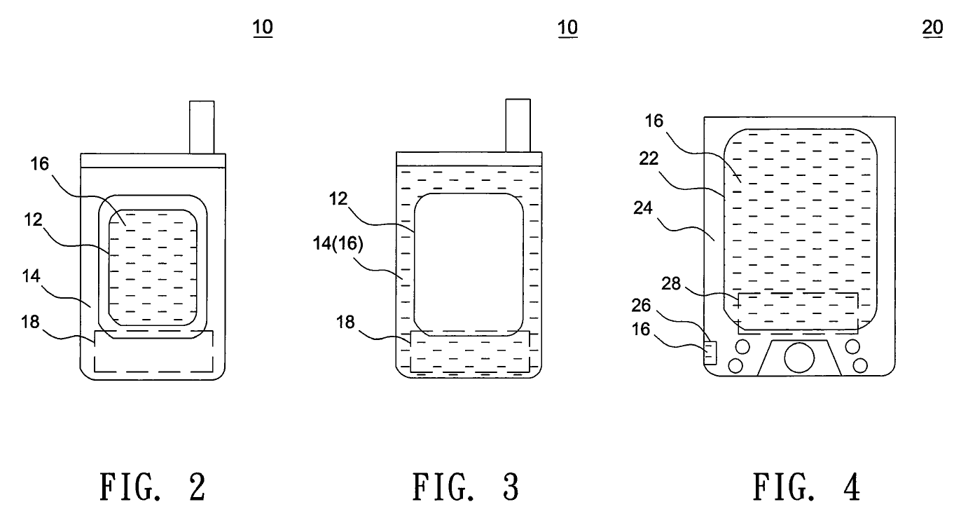

FIG. 2 shows a schematic diagram illustrating an electronic device having a voltage-regulation color-changing element according to an embodiment of the invention. Referring to FIG. 2, the electronic device is a cellular phone 10 that has a display screen 12 and a housing 14 surrounding the display screen 12. The voltage-regulation color-changing element 16 (shown by hatched lines) are provided within the distribution area of the display screen 12, and operation power of the voltage-regulation color-changing element 16 is supplied by a battery cell 18 of the cellular phone 10. The voltage-regulation color-changing element 16 is capable of tuning between different wavelength bands of reflected light to vary the display color of the display screen 12 so as to provide specific visual effects, where the reflected light is the light that is reflected by the voltage-regulation color-changing element 16. For example, ambient light incident to the voltage-regulation color-changing element 16 can be reflected thereby. Except the various visual effects are obtained, the voltage-regulation color-changing element 16 is allowed to tune a wavelength band that varies according to the data transmitted into an electronic device; in other words, a message can be recognized according to its specific display color. For example, a specific color may be set to correspond to a specific group of caller identifications, and, when a phone call is received, a user may immediately recognize the caller's identification or the group to which the caller belongs according to the display color tuned by the voltage-regulation color-changing element 16. In an alternate embodiment as shown in FIG. 3, the voltage-regulation color-changing element 16 is combined with the housing 14 of the cellular phone 10 to allow for a color-adjustable casing. Further, the display screen 12 and housing 14 may be each combined with a color-changing element 16 to allow them to have their respective colors. Besides, in one embodiment, the electronic device is a personnel digital assistant (PDA) 20 shown in FIG. 4, and the color-changing element 16 is combined with a battery charge indicator 26 instead of the display screen 12 and the housing 14. Since the voltage-regulation color-changing element 16 is capable of tuning between different wavelength bands through the power supply of a battery cell 28 of the PDA 20, the exhibited color of the color-changing element 16 may indicate the remaining useful life of the battery 28.

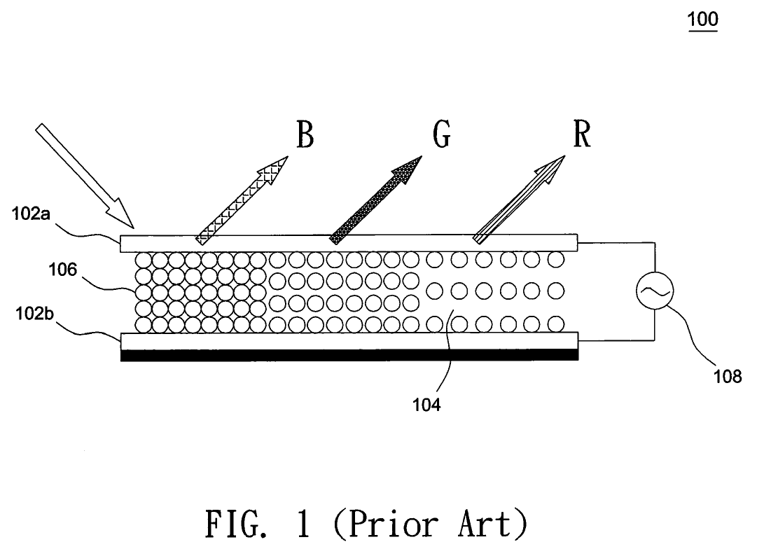

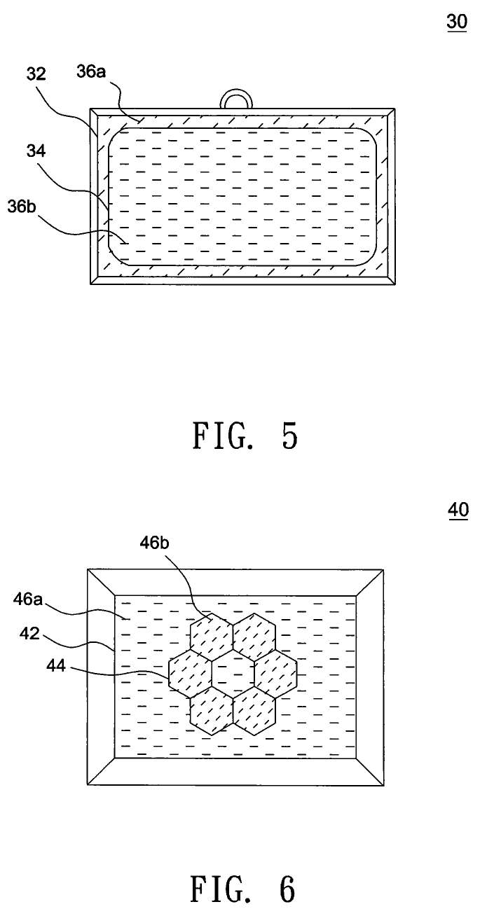

Note an electronic device combined with a voltage-regulation color-changing element is not limited to a cellular phone 10 or a personnel digital assistant 20, and it may be a note book, a digital photo frame, an e-paper, an electronic notice board, etc. As shown in FIG. 5, an outer frame 32 and a display section 34 of a notice board 30 may have different colors when they are combined with voltage-regulation color-changing elements 36a and 36b, respectively. Besides, the voltage-regulation color-changing element 36b may bring color to gray-level pixel data shown on the display section 34. Alternatively, the voltage-regulation color-changing element may be combined with a function window of home electric appliances to indicate different massages by various display colors. In one embodiment, the voltage-regulation color-changing element 36b may, similar to the color-changing element 100 shown in FIG. 1, include a pair of electrodes 102a and 102b, a cross-linked metallopolymer 104, and plenty of silica microspheres 106 embedded within the cross-linked metallopolymer 104. Through the regulation of applied voltages, red light R, green light G, blue light B or other wavelength bands of reflected light are obtained to bring out color-changing effects.

Further, in one embodiment, the voltage-regulation color-changing element is embedded in a display screen, a housing or other section of an electronic device. For example, in case the display screen is an LCD panel and thus contains liquid crystal cells, the pair of electrodes 102a and 102b and the cross-linked metallopolymer 104 (as illustrated in FIG. 1) may be integrated into the liquid crystal cells.

FIG. 6 shows a schematic diagram illustrating another embodiment of the invention, where a voltage-regulation color-changing element is mounted on another holding device. In this embodiment as shown in FIG. 6, the holding device is a mural 40 instead of an electronic device. A first voltage-regulation color-changing element 46a is provided on a bottom plate 42 of the mural 40, and multiple second voltage-regulation color-changing element 46b are spread over an ornamental region 44 of the mural 40. For example, when the second voltage-regulation color-changing element 46b and the first voltage-regulation color-changing element 46a have an identical display color, the mural 40 is viewed as a background overall; in comparison, when the second voltage-regulation color-changing elements 46b are of different color, an ornamental pattern is shown as illustrated in FIG. 6 to create vivid visual effects. Certainly, the second voltage-regulation color-changing elements 46b may be arranged to show at least one pattern, alphabet or symbol, and the holding device combined with voltage-regulation color-changing elements 46a and 46b may be a single piece of furniture instead of the mural 40 to achieve similar visual effects. Besides, the voltage-regulation color-changing elements may be arranged on an electronic device to show at least one pattern, alphabet or symbol.

According to the above embodiments, the voltage-regulation color-changing element is combined with a holding device to bring different colors and provide specific visual effects, to deliver information by the recognition of colors, and to show at least one pattern, alphabet or symbol.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An electronic device with at least one voltage-regulation color-changing element having a display section and a housing substantially surrounding the display section, the voltage-regulation color-changing element, which is provided on at least one of the display section and the housing and supplied with a voltage by a voltage source of the electronic device, being allowed to tune between different wavelength bands of reflected light to vary the color of at least part of the electronic device so as to provide specific visual effects.

2. The electronic device as claimed in claim 1, wherein the electronic device is a cellular phone, a personnel digital assistant, a notebook, a digital photo frame, an e-paper, an electronic notice board, or one of home electric appliances.

3. The electronic device as claimed in claim 1, wherein the voltage-regulation color-changing element is allowed to tune a wavelength band that indicates a specific message.

4. The electronic device as claimed in claim 1, further comprising a battery charge indicator provided on the housing and the voltage-regulation color-changing element being combined with the battery charge indicator.

5. The electronic device as claimed in claim 1, wherein the voltage-regulation color-changing element is embedded in the electronic device.

6. The electronic device as claimed in claim 1, wherein the display section comprises liquid crystal cells, the voltage-regulation color-changing element comprises a pair of electrodes and a cross-linked metallopolymer, and the pair of electrodes and the cross-linked metallopolymer are integrated into the liquid crystal cells.

7. The electronic device as claimed in claim 1, wherein the voltage-regulation color-changing element brings color to gray-level pixel data shown on the display section.

8. The electronic device as claimed in claim 1, wherein the voltage-regulation color-changing element is allowed to tune a wavelength band that varies according to the display data transmitted into the electronic device.

9. The electronic device as claimed in claim 1, wherein the voltage-regulation color-changing element comprises:
a pair of electrodes facing to each other;
a cross-linked metallopolymer provided between the pair of electrodes; and
multiple silica microspheres embedded within the cross-linked metallopolymer.

10. A holding device with at least one voltage-regulation color-changing element having a display section and a background section surrounding the display section, the voltage-regulation color-changing element, which is provided on both the display section and the background section and supplied with a voltage by a voltage source, being allowed to tune between different wavelength bands of reflected light to vary the color of the display section and the background section so as to provide specific visual effects.

11. The holding device as claimed in claim 10, wherein the holding device is a mural or a single piece of furniture.

12. The holding device as claimed in claim 10, wherein the display section of the holding device is combined with a plurality of voltage-regulation color-changing elements that are arranged to show at least one pattern, alphabet or symbol.

13. The holding device as claimed in claim 10, wherein the holding device is an electronic device.

14. The holding device as claimed in claim 13, wherein the background section is a housing of the electronic device.

15. The holding device as claimed in claim 10, wherein the holding device is a cellular phone, a personnel digital assistant, a notebook, a digital photo frame, an e-paper, an electronic notice board, or one of home electric appliances.

16. The holding device as claimed in claim 10, wherein the voltage-regulation color-changing element comprises:
a pair of electrodes facing to each other;
a cross-linked metallopolymer provided between the pair of electrodes; and
multiple silica microspheres embedded within the cross-linked metallopolymer.
